(19) United States
(12) Patent Application Publication
(10) Pub. No.: US 2024/0196247 A1
(43) Pub. Date: Jun. 13, 2024

(54) METHOD FOR GROUP BASED L1-SINR MEASUREMENT AND REPORT

(71) Applicant: APPLE INC., Cupertino, CA (US)

(72) Inventors: Yushu Zhang; Chunxuan Ye, San Diego, CA (US); Dawei Zhang, Saratoga, CA (US); Haitong Sun, Cupertino, CA (US); Hong He, San Jose, CA (US); Huaning Niu, San Jose, CA (US); Oghenekome Oteri, San Diego, CA (US); Seyed Ali Akbar Fakoorian, San Diego, CA (US); Wei Zeng, Saratoga, CA (US)

(21) Appl. No.: 17/905,218

(22) PCT Filed: Sep. 24, 2021
(86) PCT No.: PCT/CN2021/120068

§ 371 Date: Aug. 29, 2022

(51) Int. Cl. H04W 24/10; H04B 7/06; H04B 17/336; H04W 56/00

(52) U.S. Cl. CPC H04W 24/10; H04B 7/0626; H04B 7/06968; H04B 17/336; H04W 56/0015

(57) ABSTRACT

The present disclosure relates to methods and devices for group based Layer 1 Signal to Interference plus Noise Ratio (L1-SINR) measurement and report. The system according to the present disclosure includes at least a network device and a wireless device. A network device (such as a gNB) including at least a first Transmission and Reception Point (TRP) and a second TRP may generate a message used for a wireless device (such as a user equipment (UE)) to perform L1-SINR measurement, wherein the L1-SINR measurement is related to inter-beam interference for beams associated with the first TRP and the second TRP. The message may at least include: (1) a first channel measurement resource (CMR) set including multiple CMRs for the first TRP, and a first interference measurement resource (IMR) set including multiple IMRs for the first TRP, which is corresponding to the first CMR set; (2) a second CMR set including multiple CMRs for the second TRP, and a second IMR set including multiple IMRs for the second TRP, which is corresponding to the second CMR set; and (3) relation information, indicating the relation between the first CMR set and the second IMR set, and the relation between the second CMR set and the first IMR set. The network device sends the message to the wireless device, such that the wireless device may perform the L1-SINR measurement with respect to multiple CMR pairs at least based on the received message and then send corresponding report of the L1-SINR measurement to the network device.

### TECHNICAL FIELD

This application relates generally to wireless communication systems, including devices, systems, and methods for group based Layer 1 Signal to interference plus Noise Ratio (L1-SINR) measurement and report.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

Embodiments are presented herein of devices, systems, and methods for group based Layer 1 Signal to Interference plus Noise Ratio (L1-SINR) measurement and report. The present disclosure is directed to several critical issues for configurations for inter-beam interference measurement for beams associated with multiple Transmission and Reception Points (TRPs) and corresponding reporting of the measurement. These critical issues at least include determinations of Channel Measurement Resources (CMRs), Interference Measurement Resources (IMRs) related to multiple TRPs and their relations during the L1-SINR measurement and report.

According to the techniques described herein, a network device (such as a gNB) including at least a first TRP and a second TRP, may be configured to generate a message used for a wireless device (such as an user equipment (UE)) to perform L1-SINR measurement, wherein the L1-SINR measurement is related to inter-beam interference for beams associated with the first TRP and the second TRP. The message may at least include: a first CMR set including multiple CMRs for the first TRP, and a first IMR set including multiple IMRs for the first TRP, which is corresponding to the first CMR set; a second CMR set including multiple CMRs for the second TRP, and a second IMR set including multiple IMRs for the second TRP, which is corresponding to the second CMR set; and relation information, indicating the relation between the first CMR set and the second IMR set, and the relation between the second CMR set and the first IMR set. The network device may then send the message to the wireless device.

Subsequently, the wireless device may receive the message from the network device, and then perform L1-SINR measurement with respect to multiple CMR pairs at least based on the received message. The wireless device may then send L1-SINR report including L1-SINR measurement results to the network device, wherein the L1-SINR report may include measurement results related to inter-beam interference for beams associated with the first TRP and the second TRP.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example configuration of Rx beams for multi-TRP scenario, according to embodiments disclosed herein.

FIG. 4 is a flowchart diagram illustrating an example method for a network device for supporting group based L1-SINR measurement, according to embodiments disclosed herein.

FIG. 5 is a flowchart diagram illustrating an example method for a wireless device for supporting group based L1-SINR measurement, according to embodiments disclosed herein.

FIG. 6 illustrates an example configuration for CMRs and IMRs according to Option 1 disclosed herein.

FIG. 7 illustrates an example configuration of Rx beams for multi-TRP scenario, according to Option 1 disclosed herein.

FIG. 8 illustrates an example configuration for CMRs and IMRs according to Option 2 disclosed herein.

FIG. 9 illustrates an example configuration for CMRs according to Option 3 disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

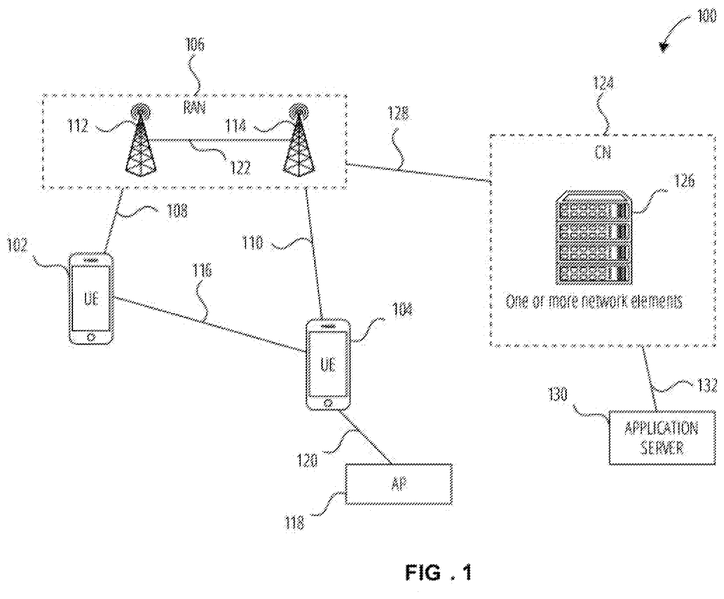

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

In some embodiments, base station 112 or base station 114 may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB may include one or more transmission and reception points (TRPs). In addition, a UE capable of operating according to 5G NR may be connected to one or more TRPs within one or more gNBs. For example, it may be possible that that one or more base stations support joint transmission, such that UE may be able to receive transmissions from multiple base stations (and/or multiple TRPs provided by the same base station).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132,

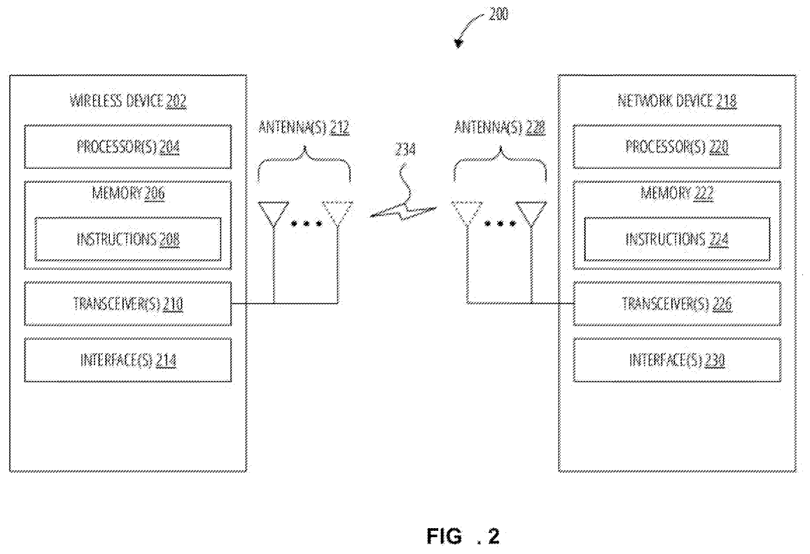

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

### ACRONYMS

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
BWP: Bandwidth Part
DL: Downlink
UL: Uplink
Tx: Transmit
Rx: Receive
LTE: Long Term Evolution
NR: New Radio
5GS: 5G System
5GC/5GCN: 5G Core Network
IE: Information Element
CE: Control Element
MAC: Medium Access Control
RACH: Random Access Channel
SSB: Synchronization Signal Block
CSI-RS: Channel State information Reference Signal
CSI-IM: Channel State Information Interference Measurement
CMR: Channel Measurement Resource
IMR: Interference Measurement Resource
PDCCH: Physical Downlink Control Channel
PDSCH: Physical Downlink Shared Channel
RRC: Radio Resource Control
RRM: Radio Resource Management
RS: Reference Signal
RSRP: Reference Signal Received Power
SINR: Signal to Interference plus Noise Ratio
TCI: Transmission Configuration Indicator
TRP: Transmission and Reception Points
DCI: Downlink Control Indicator
QCL: Quasi Co-Location

### Legacy L1-RSRP and L1-SINR

According to 3GPP technical specification of 38 series, there are three layers in LTE and NR systems, including Layer 1 (L1): physical (PHY) layer; Layer 2 (L2): Medium Access Control (MAC) layer; and Layer 3 (L3): Radio Resource Control (RRC) Layer. Conventionally, Reference Signal Received Power (RSRP) measurement and Signal to Interference plus Noise Ratio (SINR) measurement are conducted in L1 layer.

As aforementioned, a UE may communicate to one or more TRPs within one or more gNBs. According to Rel-16 of 3GPP technical specification of 38 series, group based beam reporting is supported. For example, a UE may perform L1-RSRP measurement and L1-SINR measurement for multiple beams transmitted from multiple TRPs or multiple gNBs, without distinguishing or identifying the source of the interference.

For both L1-RSRP and L1-SINR measurements, a gNB may configure a set of channel measurement resources (CMRs) for its all associated TRPs (or gNBs). The CMR may be Synchronization Signal Block (SSB) or Channel State Information Reference Signal (CSI-RS). In addition, for L1-SINR measurement, the gNB may configure Interference Measurement resources (IMRs) for its associated TRPs. The IMR may include non-zero power (NZP) IMR, e.g., CSI-RS, and zero power (ZP) IMR, e.g., CSI-IM. Normally, the NZP IMR is associated with interference coming from the same cell as CMR, while the ZP IMR is associated with interference coming from neighboring cell(s). During L1-SINR measurement, a UE can use the same receive (Rx) beam to receive the CMR and its associated NZP-IMR and ZP-IMR. The receiving power measured from the CMR is regarded as useful signal power, while the total receiving power measured from the NZP-IMR and the ZP-IMR is regarded as interference power. Through the above operation, a UE may perform L1-RSRP and L-SINR measurement and report for each measured CMR transmitted via a transmit (Tx) beam.

According to Rel-17 of 3GPP technical specification of 38 series, group based beam reporting is enhanced to support multi-TRP operation. For example, a UE may perform L1-RSRP measurement and L1-SINR measurement for multiple beams transmitted from multiple separate TRPs and the UE may send corresponding reports of L1-RSRP and L1-SINR measurements to the gNB including the multiple TRPs.

Different from Rel-16, for both L1-RSRP and L1-SINR measurements, a gNB may configure multiple sets of channel measurement resources (CMRs) for its associated multiple TRPs, with each set corresponding to one TRP. The CMR may be Synchronization Signal Block (SSB) or Channel State Information Reference Signal (CSI-RS).

Currently, L1-RSRP measurement is supported for multi-TRP operation, but L1-SINR measurement related to inter-beam interference with respect to a specific set of Tx beams used for transmitting CMRs associated with multiple TRPs is not supported. Therefore, an important issue is how to measure the inter-beam interference for beams associated with multiple TRPs during L1-SINR measurement.

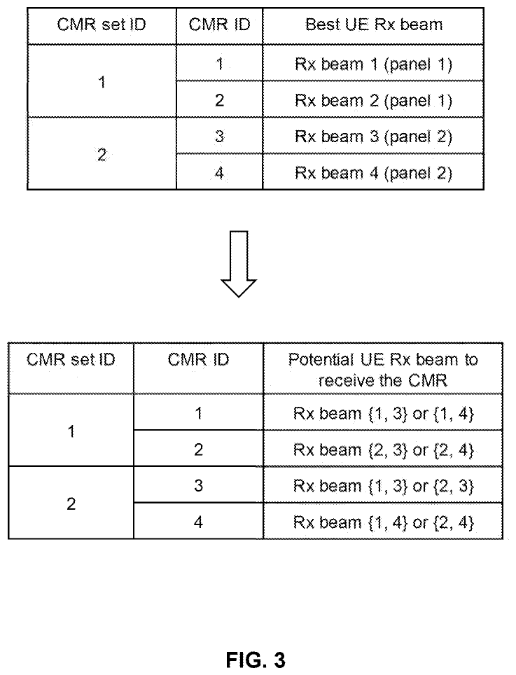

Taking 2-TRP scenario as an example, since a pair of Tx beams transmitting CMRs from two TRPs are commonly non-orthogonal, thus it would be challenging for a UE to decide its Rx beams for receiving each CMR. FIG. 3 illustrates an example configuration for the above-mentioned scenario including 2 TRPs (e.g., TRP1 and TRP2). In FIG. 3, CMR set 1 is associated with TRP1 and CMR set 2 is associated with TRP2. Each CMR set includes two CMRs, which are transmitted via two separate Tx beams from the TRP associated with that CMR set. The upper portion of FIG. 3 shows the best Rx beam of a UE to receive each of CMRs for each TRP, where the UE uses two antenna panels (panel 1 and panel 2) to generate appropriate Rx beams for receiving CMRs from two TRPs, respectively. For example, the UE uses antenna panel 1 to generate different Rx beams for receiving corresponding CMRs from TRP1. The lower portion of FIG. 3 shows the potential UE Rx beam pairs to receive each CMR. For example, if UE uses Rx beams {1, 3} to receive CMR1, it can only measure inter-beam interference between CMR1 and CMR 3; if UE uses Rx beams {1, 4} to receive CMR1, it can only measure inter-beam interference between CMR1 and CMR4. Therefore, a method to support inter-beam interference measurement for multi-TRP operation based on L1-SINR is required.

The present disclosure provides novel methods for group based L1-SINR measurement and report.

### Method for Group Based L1-SINR Measurement and Report

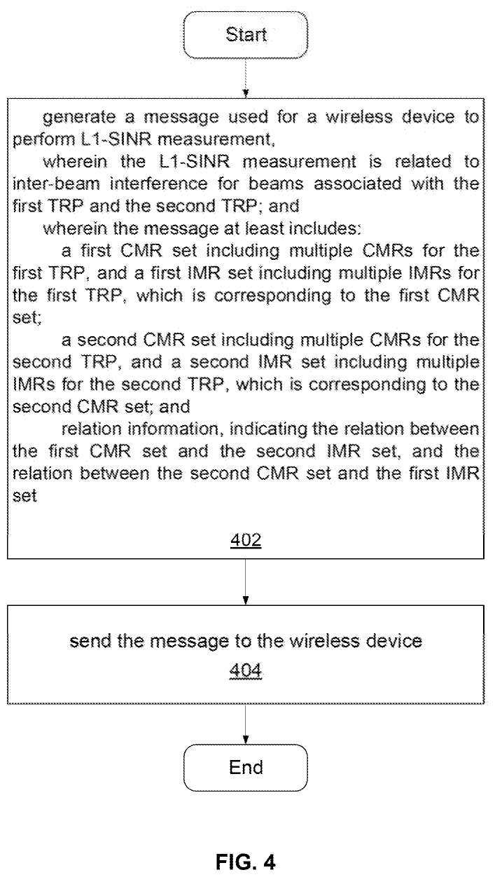

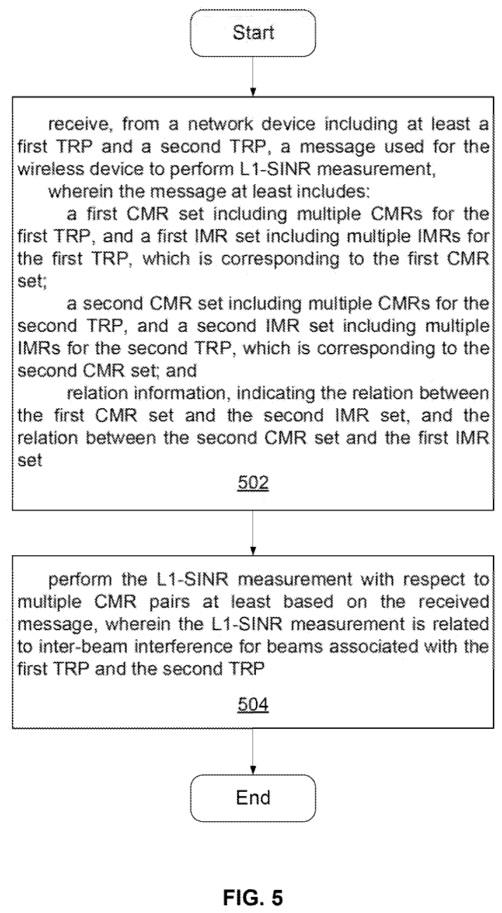

FIG. 4 and FIG. 5 are flow diagrams illustrating an example method for a network device (e.g., a gNB) and an example method for a wireless device (e.g., a UE), respectively, in order to support group based L1-SINR measurement and report related to inter-beam interference for beams associated with multiple TRPs included in the network device, at least according to some embodiments.

Aspects of the method of FIG. 4 may be implemented by a network device such as a base station 112 or 114 (e.g., a gNB) including at least two TRPs (e.g., a first TRP and a second TRP) in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. As shown, the method of FIG. 4 may operate as follows.

At 402, a network device (e.g., a gNB) including at least a first TRP and a second TRP may generate a message used for a wireless device (e.g., a UE) to perform L1-SINR measurement, wherein the L1-SINR measurement is related to inter-beam interference for beams associated with the first TRP and the second TRP. The message may include at least the following: (1) a first channel measurement resource (CMR) set including multiple CMRs for the first TRP, and a first interference measurement resource (IMR) set including multiple IMRs for the first TRP, the first IMR set being corresponding to the first CMR set; (2) a second CMR set including multiple CMRs for the second TRP, and a second IMR set including multiple IMRs for the second TRP, the second IMR set being corresponding to the second CMR set; and (3) relation information, indicating the relation between the first CMR set and the second IMR set, and the relation between the second CMR set and the first IMR set.

At 404, the network device may send the message to the wireless device, such that the wireless device may perform the L1-SINR measurement with respect to multiple CMR pairs and send a report of the measurement to the network device.

Embodiments contemplated herein include an apparatus comprising means to perform one or more elements of the method according to the present disclosure. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method according to the present disclosure. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method according to the present disclosure. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method according to the present disclosure. This apparatus may be, for example, an apparatus of a base station (such as a network device 218 that is a base station, as described herein).

Embodiments contemplated herein include a signal as described in or related to one or more elements of the method according to the present disclosure.

Embodiments contemplated herein include a computer program or computer program product comprising instructions, wherein execution of the program by a processing element is to cause the processing element to carry out one or more elements of the method according to the present disclosure. The processor may be a processor of a base station (such as a processor(s) 220 of a network device 218 that is a base station, as described herein). These instructions may be, for example, located in the processor and/or on a memory of the base station (such as a memory 222 of a network device 218 that is a base station, as described herein).

Aspects of the method of FIG. 5 may be implemented by a wireless device such as a UE 102 or 104 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. As shown, the method of FIG. 5 may operate as follows.

At 502, a wireless device (e.g., a UE) may receive, from a network device (e.g., a gNB) including at least a first TRP and a second TRP, a message used for the wireless device to perform L1-SINR measurement. The message may include at least the following: (1) a first CMR set including multiple CMRs for the first TRP, and a first IMR set including multiple IMRs for the first TRP, the first IMR set being corresponding to the first CMR set; (2) a second CMR set including multiple CMRs for the second TRP, and a second IMR set including multiple IMRs for the second TRP, the second IMR set being corresponding to the second CMR set; and (3) relation information, indicating the relation between the first CMR set and the second IMR set, and the relation between the second CMR set and the first IMR set.

At 504, the wireless device may perform the L1-SINR measurement with respect to multiple CMR pairs at least based on the received message, wherein the L1-SINR measurement is related to inter-beam interference for beams associated with the first TRP and the second TRP.

Embodiments contemplated herein include an apparatus comprising means to perform one or more elements of the method according to the present disclosure. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method according to the present disclosure. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method according to the present disclosure. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method according to the present disclosure. This apparatus may be, for example, an apparatus of a UE (such as a wireless device 202 that is a UE, as described herein).

Embodiments contemplated herein include a signal as described in or related to one or more elements of the method according to the present disclosure.

Embodiments contemplated herein include a computer program or computer program product comprising instructions, wherein execution of the program by a processor is to cause the processor to carry out one or more elements of the method according to the present disclosure. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

It should be understood that in various embodiments, some of the elements of the methods shown may be performed concurrently, in a different order than shown, may be substituted for by other method elements, or may be omitted. Additional elements may also be performed as desired.

The present disclosure proposes methods for group based L1-SINR measurement and report. More specifically, the present disclosure provides three options (i.e., Option 1. Option 2, and Option 3 described hereinafter) for L1-SINR measurement and report of inter-beam interference for beams associated with multiple TRPs. In each option, issues such as control signaling for CMR and/or IMR, QCL enhancement for CMR and/or IMR, and dynamic CMR pairs indication are described as below. For simplicity of illustration, L1-SINR measurement and report directed to two-TRP scenario will be described in detail. Since the present disclosure mainly focuses on inter-beam interference, thus the term “IMR” in the following description mostly refers to NZP-IMR, and the term “CSI-IM” is used to refer to ZP-IMR.

### Option 1—Configuring One IMR for One CMR

In order to support L1-SINR measurement related to inter-beam interference in multi-TRP scenario, a gNB including at least two TRPs (e.g., TRP1 and TRP2) may send a message (e.g., CSI-ReportConfig) to a UE, which indicates two CMR sets, i.e., CMR set 1 including multiple CMRs related to TRP1, and CMR set 2 including multiple CMRs related to TRP2. The CMR may be an SSB or a CSI-RS.

In this option, the gNB may configure one IMR (here refers to NZP-IMR, which may be an SSB or a CSI-RS) for each CMR in CMR set 1 and CMR set 2. IMRs corresponding to CMRs in each CMR set may form an IMR set (i.e., IMR set 1 and IMR set 2). The message sent from the gNB to the UE may indicate IMR set 1 and IMR set 2. In addition, QCL relations between CMRs in CMR set 1 and IMRs in IMR set 2, and QCL relations between CMRs in CMR set 2 and IMRs in IMR set 1 may also be indicated in the message.

After receiving the message from the gNB, the UE may determine multiple CMR pairs used to perform L1-SINR measurement related to inter-beam interference for Tx beams associated with TRP1 and TRP2 based on the QCL relation information. Each CMR pair of the multiple pairs may include one CMR in CMR set 1 and one CMR in CMR set 2. Each CMR pair (including a CMR in CMR set 1 and a CMR in CMR set 2) used for L1-SINR measurement has a specific linkage, where the IMR in IMR set 1 configured for said CMR in CMR set 1 is QCLed with said CMR in CMR set 2, and the IMR in IMR set 2 configured for said CMR in CMR set 2 is QCLed with said CMR in CMR set 1. Here, “an IMR is QCLed with a CMR” means the two measurement resources could be transmitted via the same Tx beam from the same TRP, although they may be different signals.

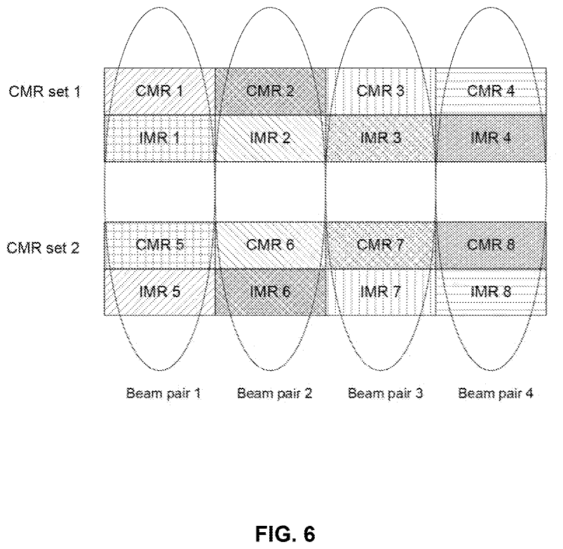

FIG. 6 illustrates an example configuration for CMRs and IMRs according to Option 1. In FIG. 6. CMR set 1 is related to TRP1, and it includes CMR1, CMR2, CMR3 and CMR4. Correspondingly, IMR set 1 includes IMR1, IMR2, IMR3 and IMR4, which are configured for CMR1, CMR2, CMR3 and CMR4, respectively. Similarly, CMR set 2 is related to TRP2, and it includes CMR5, CMR6, CMR7 and CMR8. Correspondingly, IMR set 2 includes IMR5, IMR6, IMR7 and IMR1, which are configured for CMR5, CMR6, CMR7 and CMR8, respectively. According to FIG. 6, two measurement resources illustrated in the same pattern possess QCL relation, i.e., they could be transmitted via the same Tx beam from the same TRP. For example, IMR 1 corresponding to CMR 1 in CMR set 1 is QCLed with CMR 5 in CMR set 2, and IMR 5 corresponding to CMR 5 in CMR set 2 is QCLed with CMR1 in CMR set 1. This mutual QCL relation (i.e., the linkage) leads to a beam pair (i.e., Beam pair 1), which could be also called a CMR pair (CMR 1 and CMR 5) herein, for use in L1-SINR measurement and reporting by the UE. During L1-SINR measurement, the Rx beam of the UE to receive one CMR in the CMR pair and the IMR corresponding to that CMR can be the same. For example, the UE can use the same Rx beam to receive CMR1 and IMR1 for TRP1, and use another same Rx beam to receive CMR5 and IMR5 for TRP 2 during L1-SINR measurement.

It should be noted that multiple CMRs in a CMR set could be the same signal, while the IMRs associated with these CMRs are different. That is, one TRP may remain the same Tx beam associated with multiple CMRs that are the same signal, while the interference beam related to the IMR associated with these CMRs coming from another TRP may change, thereby the UE changes its Rx beam pair accordingly.

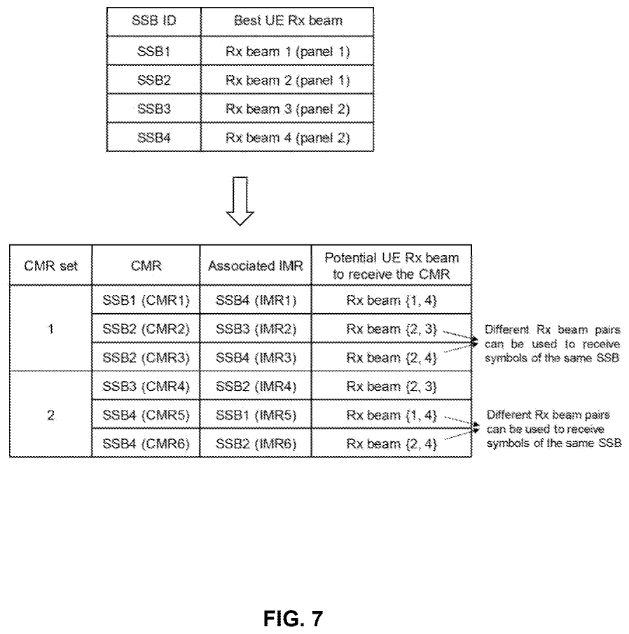

FIG. 7 illustrates an example configuration regarding the above-mentioned scenario. In FIG. 7, both CMRs and IMRs are SSB signals, e.g., each of which may take 4 symbols. Both CMR2 and CMR3 in CRM set 1 are SSB2, and their associated IMR, i.e., IMR2 and IMR3, are SSB3 and SSB4, respectively. The same signals may be considered as naturally QCLed. According to aforementioned mutual QCL relation, CMR2 and CMR4 may form a beam pair, and CMR3 and CMR6 may form a beam pair for L1-SINR measurement. During the measurements of CMR2 and CMR3 which are both symbols of SSB2, UE uses different Rx beam pairs (e.g., Rx beam {2, 3} and Rx beam {2, 4}) to receive symbols of SSB2. Similarly, During the measurements of CMR5 and CMR6 which are both symbols of SSB4. UE uses different Rx beam pairs (e.g., Rx beam {1, 4} and Rx beam {2, 4}) to receive symbols of SSB4. Thus, the UE may obtain inter-beam interference for multiple pairs of Tx beams.

Normally, the number of SSBs which are CMRs (e.g., SSB3 and SSB4) in a CMR set that have the linkage to CMRs which are the same SSB signal (e.g., SSB2) in a another CMR set has an upper limit (this number may also indicate the number of Rx beam pairs of the UE with one Rx beam remaining the same). This upper limit may be predefined by the gNB, or may be reported by the UE via UE capability signal initially. It will be understood that SSB being used as CMR and IMR is merely an example, and is not intended to be limiting. The above operation regarding using multiple Rx beam pairs to receive CMRs which are the same signal is also applicable to the scenario where CSI-RS is used as CMR and/or IMR.

As aforementioned, the CSR and IMR could be SSB or CSI-RS. According to embodiments of the present disclosure, the CSI-RS includes semi-persistent CSI-RS or periodic CSI-RS.

Conventionally, the message including information of CMRs, IMRs and QCL relations are transmitted from the gNB to the UE via RRC signaling. It will be appreciated that the message could be extended to be transmitted via MAC CE replacing RRC signaling in order to facilitate the transmission. Similarly, an updated message could also be transmitted via MAC CE besides RRC signaling when there exists a change in measurement resources or QCL relations. As an example, a MAC CE used for transmitting an updated message may include the following information: message ID (e.g., CSI-ReportConfig ID); CMR set ID; CMR ID; New CMR and/or IMR ID. When CMR and IMR are CSI-RS, the MAC CE used for transmitting an updated message may include new QCL relations or a new Transmission Configuration Indicator (TCI) which indicates a configuration of new QCL relations instead of the above information. Further, when CSI-RS used for IMR is semi-persistent CSI-RS, the updated message could be directly transmitted via MAC CE, since the QCL for semi-persistent CSI-RS could be directly updated via MAC CE.

### Option 2—Configuring One or More IMRs for One CMR

Similar to Option 1, in order to support L1-SINR measurement related to inter-beam interference in multi-TRP scenario, a gNB including at least two TRPs (e.g., TRP1 and TRP2) may send a message (e.g., CSI-ReportConfig) to a UE, which indicates two CMR sets, i.e., CMR set 1 including multiple CMRs related to TRP1, and CMR set 2 including multiple CMRs related to TRP2. The CMR may be SSB or CSI-RS.

In this option, the gNB may configure one or more IMRs (here refers to NZP-IMR, which may be SSB or CSI-RS) for each CMR in CMR set 1 and CMR set 2. IMRs corresponding to CMRs in each CMR set may form an IMR set (i.e., IMR set 1 and IMR set 2). The message sent from the gNB to the UE may indicate IMR set 1 and IMR set 2. In addition, QCL relations between CMRs in CMR set 1 and IMRs in IMR set 2, and QCL relations between CMRs in CMR set 2 and IMRs in IMR set 1 may also be indicated in the message.

After receiving the message from the gNB, the UE may determine multiple CMR pairs used to perform L1-SINR measurement related to inter-beam interference for Tx beams associated with TRP1 and TRP2 based on the QCL relation information. Each CMR pair of the multiple pairs may include one CMR in CMR set 1 and one CMR in CMR set 2. Each CMR pair (including a CMR in CMR set 1 and a CMR in CMR set 2) used for L1-SINR measurement has a specific linkage, where the IMR on one of multiple IMRs in IMR set 1 configured for said CMR in CMR set 1 is QCLed with said CMR in CMR set 2, and the IMR or one of multiple IMRs in IMR set 2 configured for said CMR in CMR set 2 is QCLed with said CMR in CMR set 1.

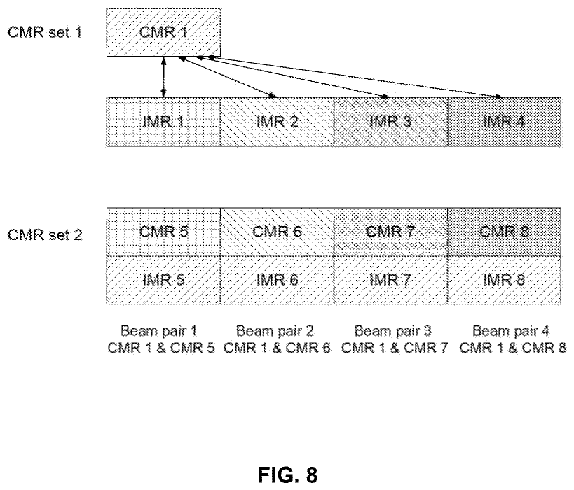

The difference between this option and Option 1 mainly lies in: this option allows configuring multiple IMRs for at least one CMR in CMR set 1 and/or at least one CMR in CMR set 2. FIG. 8 illustrates an example configuration for CMRs and IMRs according to Option 2. In FIG. 8, CMR set 1 is related to TRP1, and it includes CMR1 (and CMR set 1 may also include other CMRs, which are not shown in this figure for simplicity). Correspondingly. IMR set 1 includes IMR1, IMR2, IMR3 and IMR4, which are all configured for CMR1. CMR set 2 is related to TRP2, and it includes CMR5, CMR6, CMR7 and CMR8. Correspondingly, IMR set 2 includes IMR5, IMR6, IMR7 and IMR8, which are configured for CMR5, CMR6, CMR7 and CMR$, respectively. According to FIG. 8, two measurement resources illustrated in the same pattern possess QCL relation, i.e., they could be transmitted via the same Tx beam from the same TRP. For example, IMR 1 which is one of multiple IMRs (including IMR1-IMR4) corresponding to CMR 1 in CMR set 1 is QCLed with CMR 5 in CMR set 2, and IMR 5 which is corresponding to CMR 5 in CMR set 2 is QCLed with CMR1 in CMR set 1. This mutual QCL relation (i.e., the linkage) leads to a beam pair (i.e., Beam pair 1), which could be also called a CMR pair (CMR 1 and CMR 5) herein, for use in L1-SINR measurement and reporting by the UE. There are 4 CMR pairs shown in FIG. 8, each of which includes CMR 1 in CMR set 1.

As an example, referring to FIG. 8, during L1-SINR measurement for Beam pair 3 (i.e., CMR 1 and CMR7) by the UE, two SINR values are obtained. The L1-SINR value for CMR 1 may be measured from CMR1 and IMR3 (which the UE uses the same Rx beam to receive), and the L1-SINR value for CMR7 may be measured from CMR7 and IMR7 (which the UE uses another same Rx beam to receive).

Comparing with implementations of Option 1 where multiple CMRs are the same signal, the number of CMRs in a CMR set is reduced according to Option 2, since Option 2 allows one-to-multiple correspondence between CMRs and IMRs related to the same TRP while Option 1 only allows one-to-one correspondence between CMRs and IMRs related to the same TRP. Therefore, the message sent from the gNB to the UE for L1-SINR measurement and the reporting message from the UE to the gNB according to Option 2 may achieve reduced signaling overhead and increased flexibility compared to Option 1.

In this option, one CMR may correspond to multiple IMRs for a TRP. Normally, the number of CMRs (e.g., CMR5, CMR6, CMR7, and CMR8) that have the linkage to a CMR (e.g., CMR1) has an upper limit. This upper limit may be predefined by the gNB, or may be reported by the UE via UE capability signal initially.

As aforementioned, the CSR and IMR could be SSB or CSI-RS. According to embodiments of the present disclosure, the CSI-RS includes semi-persistent CSI-RS or periodic CSI-RS.

Similar to Option 1, in this option, the message including information of CMRs, IMRs and QCL relations may be transmitted from the gNB to the UE via RRC signaling or MAC CE. An updated message may be transmitted via RRC signaling or MAC CE. As an example, a MAC CE used for transmitting an updated message may include the following information: message ID (e.g., CSI-ReportConfig ID); CMR set ID; CMR ID; New CMR and/or IMR ID. When CMR and IMR are CSI-RS, the MAC CE used for transmitting an updated message may include new QCL relations or a new Transmission Configuration Indicator (TCI) which indicates a configuration of new QCL relations instead of the above information. Further, when CSI-RS used for IMR is semi-persistent CSI-RS, the updated message could be directly transmitted via MAC CE, since the QCL for semi-persistent CSI-RS could be directly updated via MAC CE.

### Option 3—Using CMR as IMR

Similar to other options, in order to support L1-SINR measurement related to inter-beam interference in multi-TRP scenario, a gNB including at least two TRPs (e.g., TRP1 and TRP2) may send a message (e.g., CSI-ReportConfig) to a UE, which indicates two CMR sets, i.e., CMR set 1 including multiple CMRs related to TRP1, and CMR set 2 including multiple CMRs related to TRP2. The CMR may be SSB or CSI-RS.

In this option, the gNB may not need to separately configure any IMR for each CMR. Instead, the message includes relation information indicating that the CMRs for a TRP could be used as IMRs for another TRP. Specifically, the relation information indicates that CMR set 1 could be used as IMR set 2 corresponding to CMR set 2, and CMR set 2 could be used as IMR set 1 corresponding to CMR set 1. Thus, one CMR in CMR set 1 may correspond to one CMR in CMR set 2, and they act as the IMR for each other.

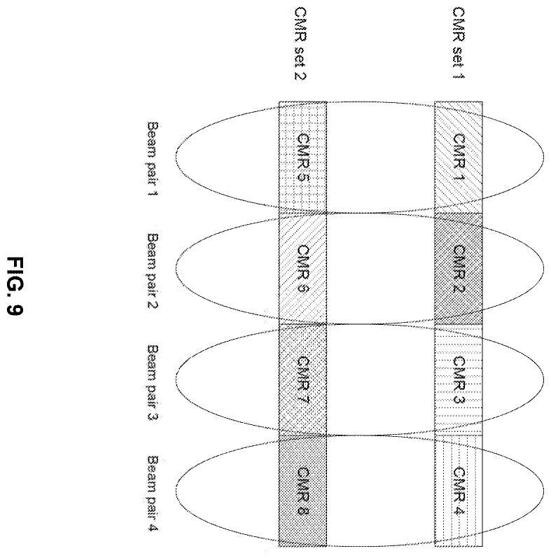

FIG. 9 illustrates an example configuration for CMRs according to Option 3. In FIG. 9, CMR set 1 is related to TRP1, and it includes CMR1, CMR2, CMR3 and CMR4. CMR set 2 is related to TRP2, and it includes CMR5, CMR6, CMR7 and CMR8. As an example, the message indicates that CMR 1 in CMR set 1 may be used as IMR corresponding to CMR5 in CMR set 2, and CMR5 in CMR set 2 may be used as IMR corresponding to CMR1 in CMR set 1, then this linkage causes them to form a beam pair, i.e., Beam pair 1, which could be also called a CMR pair (CMR 1 and CMR 5) herein, for use in L1-SINR measurement and reporting by the UE.

In this option, multiple CMRs in a CMR set could be the same signal. Normally, the number of CMRs in one CMR set that have the linkage to multiple CMRs in another CMR set which are the same signal has an upper limit (this number may also indicate the number of Rx beam pairs of the UE with one Rx beam remaining the same during measurement). This upper limit may be predefined by the gNB, or may be reported by the UE via UE capability signal initially.

Different from Option 1 and Option 2, CMRs in this option may be used as both CMR and IMR, thus it is possible that the UE fails to perform L1-SINR measurement related to inter-beam interference for a beam pair since CMRs are likely to be occupied. Therefore, a one-bit indicator may be added in UE capability signal or in L1-SINR report. For example, when the one-bit indicator is included in a report of L1-SINR measurement for a CMR pair, this one-bit indicator may be set to 1 to indicate that an L1-SINR measurement for that CMR pair has been conducted, and this one-bit indicator may be set to 0 to indicate an L1-SINR measurement for that CMR pair has not been conducted.

As aforementioned, the CSR could be SSB or CSI-RS. According to embodiments of the present disclosure, the CSI-RS includes semi-persistent CSI-RS or periodic CSI-RS.

It will be appreciated that the message including information of CMRs and relation information indicating CMRs being used as IMRs may be transmitted from the gNB to the UE via RRC signaling or MAC CE. It will be also appreciated that an updated message could also be transmitted via RRC signaling or MAC CE.

According to methods of Option 1, Option 2 or Option 3, during L1-SINR measurement for each CMR pair, a UE may obtain two SINR values corresponding to two CMRs in the CMR pair respectively. Then, channel capacity regarding this CMR pair may be calculated based on two SINR values. For example, the L1-SINR report for this CMR pair may include CMR ID for each CMR, and SINR value for each CMR (optionally, a one-bit indicator as described above may be included in L1-SINR report in Option 3). It could be understood that it may not be necessary for the UE to report measurement results of all CMR pairs to the gNB. Instead, the UE may only report one or more measured CMR pairs that achieve the highest channel capacity or that achieve the channel capacity exceeding a pre-defined threshold to the gNB. The gNB establishes knowledge regarding which CMR pair(s) related to TRP1 and TRP2 lead(s) to minimum inter-beam interference.

### Other Issues and Extensions for Option 1, Option 2, and Option 3

As aforementioned, the term “IMR” when introducing Options 1-3 mostly refers to NZP-IMR since the inter-beam interference for beams related to two TRPs are mainly described herein. Additionally, a UE may receive additional information from a gNB, where the additional information indicates configuring a ZP-IMR (e.g., CSI-IM) for each CMR in each CMR set. After that, the UE may perform L1-SINR measurement further based on the additional information. Therefore, the total receiving power of the interference would be calculated as the sum of receiving power of NZP-IMR (or CMR used as NZP-IMR) and ZP-IMR (e.g., CSI-IM) during L1-SINR measurement.

According to some implementations, the above-mentioned message sent from the gNB to the UE may be generated based on priori information acquired by the gNB. The priori information may include a report of previous L1-RSRP measurement performed by the UE associated with the two TRPs related to this message (e.g., TRP1 and TRP2), and other previous information that those skilled in the art could conceive. As an example, priori information regarding previous L1-RSRP report may indicate which Tx beams may be received by the UE simultaneously, as well as beam quality for each Tx beam without inter-beam interference. This priori information may facilitate CMR pairing in L1-SINR measurement for inter-beam interference. It will be appreciated that in such a case, a UE supporting multi-TRP group based L1-SINR measurement may first indicate that it supports multi-TRP group based L1-RSRP measurement via UE capability signal initially. According to some embodiments of the present disclosure, a change in the priori information may also lead to an update of the message.

It should be understood that the UE may not perform L1-SINR measurement for a pair of CMRs related to two TRPs that lacks a linkage (e.g., the two CMRs in this pair and corresponding IMRs do not satisfy mutual QCL relation according to Option 1 and Option 2, or the two CMRs in this pair cannot be used as NZP-IMRs mutually according to Option 3). In this regard, the UE may choose one of the following operations: (1) not generating an L1-SINR report for this pair of CMRs; and (2) generating an L1-SINR report for this pair of CMRs, but this report does not include inter-beam interference measurement result for two beams associated with two CMRs in this pair of CMRs.

For Options 1-3, since the UE may need to try different Rx beam pairs to receive signals in different instances, thus the measurement restriction (which only allows the UE to use one Rx beam once) may be disabled. In one example, “timeRestrictionForChannelMeasurements” in CSI-ReportConfig may be configured as “notConfigured”. In another example, “timeRestrictionForInterferenceMeasurements” in CSI-ReportConfig may be configured as ‘notConfigured’.

For aperiodic L1-SINR report, the scheduling offset for reporting may not be able to cover all CMR/IMR instances for the UE to scan all Rx beam pairs. In this regard, one of the following operations may be selected: (1) only allowing periodic or semi-persistent L-SINR measurement and reporting; and (2) introducing a large scheduling offset, e.g., multiple SSB periodicity.

It will be appreciated that although the above-mentioned methods for group based L1-SINR measurement and report are described for a scenario including two TRPs, alternatively or additionally, the above methods may also apply to scenarios where more than two TRPs are connected to a UE.

In summary, the present disclosure provides devices and methods for group based L1-SINR measurement and report in multi-TRP scenario. Specifically, three options are provided for a gNB to notify a UE necessary information to perform L1-SINR measurement associated with inter-beam interference for beams related to multiple TRPs. After the UE performs L1-SINR measurement for multiple CMR groups related to multiple TRPs (e.g., when there are two TRPs, a CMR group is a CMR pair), the UE may report to the gNB one or more CMR groups that achieve the highest channel capacity or that achieve the channel capacity exceeding a pre-defined threshold. Based on L1-SINR report, the gNB may establish its knowledge regarding which CMR group(s) related to the multiple TRPs lead(s) to minimum inter-beam interference, thereby leading to enhanced channel capacity and system performance. In addition, the gNB may dynamically update information for L1-SINR measurement to the UE according to the present disclosure, which further adds accuracy of the measurement and report.

In the following further exemplary embodiments are provided.

One set of embodiments may include a network device including at least a first Transmission and Reception Point (TRP) and a second TRP, the network device comprising: at least one antenna; at least one radio coupled to the at least one antenna; and a processor coupled to the at least one radio; wherein the network device is configured to: generate a message used for a wireless device to perform Layer 1 Signal to Interference plus Noise Ratio (L1-SINR) measurement, wherein the L1-SINR measurement is related to inter-beam interference for beams associated with the first TRP and the second TRP; and wherein the message at least includes: a first channel measurement resource (CMR) set including multiple CMRs for the first TRP, and a first interference measurement resource (IMR) set including multiple IMRs for the first TRP, which is corresponding to the first CMR set; a second CMR set including multiple CMRs for the second TRP, and a second IMR set including multiple IMRs for the second TRP, which is corresponding to the second CMR set; and relation information, indicating the relation between the first CMR set and the second IMR set, and the relation between the second CMR, set and the first IMR set; and send the message to the wireless device.

According to some embodiments, each CMR in the first CMR set corresponds to one IMR in the first IMR set, and each CMR in the second CMR set corresponds to one IMR in the second IMR set; and the relation information indicates Quasi Co-Location (QCL) relations between the CMRs in the first CMR set and the IMRs in the second IMR set, and QCL relations between the CMRs in the second CMR set and the IMRs in the first IMR set.

According to some embodiments, at least one CMR in the first CMR set corresponds to multiple IMRs in the first IMR set, or at least one CMR in the second CMR set corresponds to multiple IMRs in the second IMR set; and the relation information indicates Quasi Co-Location (QCL) relations between the CMRs in the first CMR set and the IMRs in the second IMR set, and QCL relations between the CMRs in the second CMR set and the IMRs in the first IMR set.

According to some embodiments, the relation information indicates that the second CMR set is used as the first IMR set, and the first CMR set is used as the second IMR set, and each CMR in the first CMR set correspond to one CMR in the second CMR set.

According to some embodiments, the CMR includes Synchronization Signal Block (SSB) or Channel State Information Reference Signal (CSI-RS) including periodic CSI-RS or semi-persistent CSI-RS, and the IMR is non-zero power (NZP) IMR, which includes SSB or CSI-RS including periodic CSI-RS or semi-persistent CSI-RS.

According to some embodiments, the network device is further configured to: send additional information indicating configuring a zero power (ZP) IMR for each CMR in the first CMR set and a ZP IMR for each CMR in the second CMR set to the wireless device for use in the L1-SINR measurement, wherein the ZP IMR includes Channel State Information Interference Measurement (CSI-IM).

According to some embodiments, the message is generated based on priori information, which includes at least a report of previous L1 Reference Signal Received Power (L1-RSRP) measurement performed by the wireless device associated with the first TRP and the second TRP.

According to some embodiments, the network device is further configured to: update the message based on at least one of the following: a change of CMR, IMR or relation information included in the message; and a change of the priori information.

According to some embodiments, the network device is further configured to: send the message or the updated message to the wireless device via Radio Resource Control (RRC) signaling or Medium Access Control (MAC) Control Element (CE).

Another set of embodiments may include a wireless device, comprising: at least one antenna; at least one radio coupled to the at least one antenna; and one or more processor coupled to the at least one radio; wherein the one or more processors are configured to cause the wireless device to: receive, from a network device including at least a first Transmission and Reception Point (TRP) and a second TRP, a message used for the wireless device to perform Layer 1 Signal to Interference plus Noise Ratio (L1-SINR) measurement, wherein the message at least includes: a first channel measurement resource (CMR) set including multiple CMRs for the first TRP, and a first interference measurement resource (IMR) set including multiple IMRs for the first TRP, which is corresponding to the first CMR set; a second CMR set including multiple CMRs for the second TRP, and a second IMR set including multiple IMRs for the second TRP, which is corresponding to the second CMR set; and relation information, indicating the relation between the first CMR set and the second IMR set, and the relation between the second CMR set and the first IMR set; and perform the L1-SINR measurement with respect to multiple CMR pairs at least based on the received message, wherein the L1-SINR measurement is related to inter-beam interference for beams associated with the first TRP and the second TRP.

According to some embodiments, each CMR in the first CMR set corresponds to one IMR in the first IMR set, and each CMR in the second CMR set corresponds to one IMR in the second IMR set; and the relation information indicates Quasi Co-Location (QCL) relations between the CMRs in the first CMR set and the IMRs in the second IMR set, and QCL relations between the CMRs in the second CMR set and the IMRs in the first IMR set.

According to some embodiments, each CMR pair of the multiple CMR pairs for the L1-SINR measurement includes one CMR in the first CMR set and one CMR in the second CMR set, and the IMR in the first IMR set corresponding to the one CMR in the first CMR set is QCLed with the one CMR in the second CMR set, and the IMR in the second IMR set corresponding to the one CMR in the second CMR set is QCLed with the one CMR in the first CMR set.

According to some embodiments, at least one CMR in the first CMR set corresponds to multiple IMRs in the first IMR set, or at least one CMR in the second CMR set corresponds to multiple IMRs in the second IMR set; and the relation information indicates Quasi Co-Location (QCL) relations between the CMRs in the first CMR set and the IMRs in the second IMR set, and QCL relations between the CMRs in the second CMR set and the IMRs in the first IMR set.

According to some embodiments, each CMR pair of the multiple CMR pairs for the L1-SINR measurement includes one CMR in the first CMR set and one CMR in the second CMR set, and the IMR or one of multiple IMRs in the first IMR set corresponding to the one CMR in the first CMR set is QCLed with the one CMR in the second CMR set, and the IMR or one of multiple IMRs in the second IMR set corresponding to the one CMR in the second CMR set is QCLed with the one CMR in the first CMR set.

According to some embodiments, the relation information indicates that the second CMR set is used as the first IMR set, and the first CMR set is used as the second IMR set, and each CMR in the first CMR set correspond to one CMR in the second CMR set.

According to some embodiments, each CMR pair of the multiple CMR pairs for the L1-SINR measurement includes one CMR in the first CMR set and one CMR in the second CMR set, and the one CMR in the second CMR set is used as the IMR corresponding to the one CMR in the first CMR set, and the one CMR in the first CMR set is used as the IMR corresponding to the one CMR in the second CMR set.

According to some embodiments, performing the L1-SINR measurement includes: for each CMR pair of the multiple CMR pairs including one CMR in the first CMR set and one CMR in the second CMR set: using one receive (Rx) beam to receive the one CMR in the first CMR set and the IMR or one of multiple IMRs in the first IMR set corresponding to the one CMR in the first CMR set that is QCLed with the one CMR in the second CMR set; and using another Rx beam to receive the one CMR in the second CMR set and the IMR or one of multiple IMRs in the second IMR set corresponding to the one CMR in the second CMR set that is QCLed with the one CMR in the first CMR set.

According to some embodiments, the CMR includes Synchronization Signal Block (SSB) or Channel State Information Reference Signal (CSI-RS) including periodic CSI-RS or semi-persistent CSI-RS, and the IMR is non-zero power (NZP) IMR, which includes SSB or CSI-RS including periodic CSI-RS or semi-persistent CSI-RS.

According to some embodiments, the wireless device is further configured to: receive additional information from the network device, wherein the additional information indicates configuring a zero power (ZP) IMR for each CMR in the first CMR set and a ZP IMR configured for each CMR in the second CMR set; and perform the L1-SINR measurement further based on the additional information, wherein the ZP IMR includes Channel State Information Interference Measurement (CSI-IM).

According to some embodiments, the wireless device is further configured to: for a CMR pair which does not belong to the multiple CMR pairs used to perform the L1-SINR measurement: do not generate a report of the L1-SINR measurement for the CMR pair; or generate a report of the L1-SINR measurement for the CMR pair, and the report does not include information related to inter-beam interference for beams associated with the first TRP and the second TRP.

According to some embodiments, a one-bit indicator is included in a report of L1-SINR measurement for a CMR pair, and when the CMR pair belongs to the multiple CMR pairs used to perform the L1-SINR measurement, the one-bit indicator is set to indicate an L1-SINR measurement for the CMR pair has been conducted, and when the CMR pair does not belong to the multiple CMR pairs, the one-bit indicator is set to indicate an L1-SINR measurement for the CMR pair has not been conducted.

According to some embodiments, the wireless device is further configured to: receive the message or an updated message from the network device via Radio Resource Control (RRC) signaling or Medium Access Control (MAC) Control Element (CE).

Yet another set of embodiments may include a method for a network device including at least a first Transmission and Reception Point (TRP) and a second TRP, comprising: generating a message used for a wireless device to perform Layer 1 Signal to Interference plus Noise Ratio (L1-SINR) measurement, wherein the L1-SINR measurement is related to inter-beam interference for beams associated with the first TRP and the second TRP; and wherein the message at least includes: a first channel measurement resource (CMR) set including multiple CMRs for the first TRP, and a first interference measurement resource (IMR) set including multiple IMRs for the first TRP, which is corresponding to the first CMR set; a second CMR set including multiple CMRs for the second TRP, and a second IMR set including multiple IMRs for the second TRP, which is corresponding to the second CMR set; and relation information, indicating the relation between the first CMR set and the second IMR set, and the relation between the second CMR set and the first IMR set; and sending the message to the wireless device.

Another exemplary embodiment may include a method for a wireless device, comprising: receiving, from a network device including at least a first Transmission and Reception Point (TRP) and a second TRP, a message used for the wireless device to perform Layer 1 Signal to Interference plus Noise Ratio (L1-SINR) measurement, wherein the message at least includes: a first channel measurement resource (CMR) set including multiple CMRs for the first TRP, and a first interference measurement resource (IMR) set including multiple IMRs for the first TRP, which is corresponding to the first CMR set; a second CMR set including multiple CMRs for the second TRP, and a second IMR set including multiple IMRs for the second TRP, which is corresponding to the second CMR set; and relation information, indicating the relation between the first CMR set and the second IMR set, and the relation between the second CMR set and the first IMR set; and performing the L1-SINR measurement with respect to multiple CMR pairs at least based on the received message, wherein the L1-SINR measurement is related to inter-beam interference for beams associated with the first TRP and the second TRP.

Yet another exemplary embodiment may include an apparatus for operating a wireless device, the apparatus comprising: a processor configured to cause the wireless device to: receive, from a network device including at least a first Transmission and Reception Point (TRP) and a second TRP, a message used for the wireless device to perform Layer 1 Signal to Interference plus Noise Ratio (L1-SINR) measurement, wherein the message at least includes: a first channel measurement resource (CMR) set including multiple CMRs for the first TRP, and a first interference measurement resource (IMR) set including multiple IMRs for the first TRP, which is corresponding to the first CMR set; a second CMR set including multiple CMRs for the second TRP, and a second IMR set including multiple IMRs for the second TRP, which is corresponding to the second CMR set; and relation information, indicating the relation between the first CMR set and the second IMR set, and the relation between the second CMR set and the first IMR set; and perform the L1-SINR measurement with respect to multiple CMR pairs at least based on the received message, wherein the L1-SINR measurement is related to inter-beam interference for beams associated with the first TRP and the second TRP.

A yet further exemplary embodiment may include a non-transitory computer-readable storage medium storing instructions, where the instructions, when executed by a computer system, cause the computer system to perform any or all parts of any of the preceding examples.

A still further exemplary embodiment may include a computer program product, comprising program instructions which, when executed by a computer, cause the computer to perform any or all parts of any of the preceding examples.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1-29. (canceled)

30. A network device including at least a first Transmission and Reception Point (TRP) and a second TRP, the network device comprising:
at least one antenna;
at least one radio coupled to the at least one antenna; and
a processor coupled to the at least one radio;
wherein the network device is configured to:
generate a message used for a wireless device to perform Layer 1 Signal to Interference plus Noise Ratio (L1-SINR) measurement,
wherein the L1-SINR measurement is related to inter-beam interference for beams associated with the first TRP and the second TRP; and
wherein the message at least includes:
a first channel measurement resource (CMR) set including multiple first CMRs for the first TRP, and a first interference measurement resource (IMR) set including multiple first IMRs for the first TRP, which is corresponding to the first CMR set;
a second CMR set including multiple second CMRs for the second TRP, and a second IMR set including multiple second IMRs for the second TRP, which is corresponding to the second CMR set; and
relation information, indicating a first relation between the first CMR set and the second IMR set, and a second relation between the second CMR set and the first IMR set; and
send the message to the wireless device.

31. The network device of claim 30, wherein:
each of the first CMRs in the first CMR set corresponds to one of the first IMRs in the first IMR set, and each second CMRs in the second CMR set corresponds to one of the second IMRs in the second IMR set; and
the relation information indicates Quasi Co-Location (QCL) relations between the first CMRs in the first CMR set and the second IMRs in the second IMR set, and QCL relations between the second CMRs in the second CMR set and the first IMRs in the first IMR set.

32. The network device of claim 30, wherein:
at least one of the first CMRs in the first CMR set corresponds to multiple of the first IMRs in the first IMR set, or at least one of the second CMRs in the second CMR set corresponds to multiple of the second IMRs in the second IMR set; and
the relation information indicates Quasi Co-Location (QCL) relations between the first CMRs in the first CMR set and the second IMRs in the second IMR set, and QCL relations between the second CMRs in the second CMR set and the first IMRs in the first IMR set.

33. The network device of claim 30, wherein:
the relation information indicates that the second CMR set is used as the first IMR set, and the first CMR set is used as the second IMR set, and
each of the first CMRs in the first CMR set correspond to one the second CMRs in the second CMR set.

34. The network device of claim 30, wherein:
at least one of the first CMRs and the second CMRs includes Synchronization Signal Block (SSB) or Channel State Information Reference Signal (CSI-RS) including periodic CSI-RS or semi-persistent CSI-RS, and
at least one of the first IMRs and the second IMRs comprises a non-zero power (NZP) IMR, which includes the SSB or the CSI-RS including the periodic CSI-RS or the semi-persistent CSI-RS.

35. The network device of claim 34, wherein the network device is further configured to:
send additional information indicating configuring a first zero power (ZP) IMR for each of the first CMRs in the first CMR set and a second ZP IMR for each of the second CMRs in the second CMR set to the wireless device for use in the L1-SINR measurement, wherein the first ZP IMR and the second ZP IMR includes Channel State Information Interference Measurement (CSI-IM).

36. The network device of claim 30, wherein:
the message is generated based on priori information, which includes at least a report of previous L1 Reference Signal Received Power (L1-RSRP) measurement performed by the wireless device associated with the first TRP and the second TRP.

37. The network device of claim 36, wherein the network device is further configured to:
update the message based on at least one of the following:
a CMR change, an IMR change, or a relation information change included in the message; and
a change of the priori information.

38. The network device of claim 37, wherein the network device is further configured to:
send the message or the updated message to the wireless device via Radio Resource Control (RRC) signaling or Medium Access Control (MAC) Control Element (CE).

39. A wireless device, comprising:
at least one antenna;
at least one radio coupled to the at least one antenna; and
one or more processor coupled to the at least one radio;
wherein the one or more processors are configured to cause the wireless device to:
receive, from a network device including at least a first Transmission and Reception Point (TRP) and a second TRP, a message used for the wireless device to perform Layer 1 Signal to Interference plus Noise Ratio (L1-SINR) measurement,
wherein the message at least includes:
a first channel measurement resource (CMR) set including multiple first CMRs for the first TRP, and a first interference measurement resource (IMR) set including multiple first IMRs for the first TRP, which is corresponding to the first CMR set;
a second CMR set including multiple second CMRs for the second TRP, and a second IMR set including multiple second IMRs for the second TRP, which is corresponding to the second CMR set; and
relation information, indicating a first relation between the first CMR set and the second IMR set, and a second relation between the second CMR set and the first IMR set; and
perform the L1-SINR measurement with respect to multiple CMR pairs at least based on the received message, wherein the L1-SINR measurement is related to inter-beam interference for beams associated with the first TRP and the second TRP.

40. The wireless device of claim 39, wherein:
each of the first CMRs in the first CMR set corresponds to one of the first IMRs in the first IMR set, and each of the second CMRs in the second CMR set corresponds to one of the second IMRs in the second IMR set; and
the relation information indicates Quasi Co-Location (QCL) relations between the first CMRs in the first CMR set and the second IMRs in the second IMR set, and QCL relations between the second CMRs in the second CMR set and the first IMRs in the first IMR set.

41. The wireless device of claim 40, wherein:
each CMR pair of the multiple CMR pairs for the L1-SINR measurement includes one of the first CMRs in the first CMR set and one of the second CMRs in the second CMR set, and
the first IMR in the first IMR set corresponding to the one of the first CMRs in the first CMR set is QCLed with the one of the second CMRs in the second CMR set, and the second IMR in the second IMR set corresponding to the one of the second CMRs in the second CMR set is QCLed with the one of the first CMRs in the first CMR set.

42. The wireless device of claim 39, wherein:
at least one of the first CMRs in the first CMR set corresponds to multiple of the first IMRs in the first IMR set, or at least one of the second CMRs in the second CMR set corresponds to multiple of the second IMRs in the second IMR set; and
the relation information indicates Quasi Co-Location (QCL) relations between the first CMRs in the first CMR set and the second IMRs in the second IMR set, and QCL relations between the second CMRs in the second CMR set and the first IMRs in the first IMR set.

43. The wireless device of claim 42, wherein:
each CMR pair of the multiple CMR pairs for the L1-SINR measurement includes one of the first CMRs in the first CMR set and one of the second CMRs in the second CMR set, and
one of the first IMRs in the first IMR set corresponding to the one of the first CMRs in the first CMR set is QCLed with the one of the second CMRs in the second CMR set, and one of the second IMRs in the second IMR set corresponding to the one of the second CMRs in the second CMR set is QCLed with the one of the first CMRs in the first CMR set.

44. The wireless device of claim 39, wherein:
the relation information indicates that the second CMR set is used as the first IMR set, and the first CMR set is used as the second IMR set, and
each of the first CMRs in the first CMR set correspond to one of the second CMRs in the second CMR set.

45. The wireless device of claim 44, wherein:
each CMR pair of the multiple CMR pairs for the L1-SINR measurement includes one of the first CMRs in the first CMR set and one of the second CMRs in the second CMR set, and
the one of the second CMRs in the second CMR set is used as a first selected IMR corresponding to the one of the first CMRs in the first CMR set, and the one of the first CMRs in the first CMR set is used as a second selected IMR corresponding to the one of the second CMRs in the second CMR set.

46. The wireless device of claim 39, wherein performing the L1-SINR measurement includes:
for each CMR pair of the multiple CMR pairs including one of the first CMRs in the first CMR set and one of the second CMRs in the second CMR set:
using one receive (Rx) beam to receive the one of the first CMRs in the first CMR set and one or more of the first IMRs in the first IMR set corresponding to the one of the first CMRs in the first CMR set that is QCLed with the one of the second CMRs in the second CMR set; and
using another Rx beam to receive the one of the second CMRs in the second CMR set and one or more of the second IMRs in the second IMR set corresponding to the one of the second CMRs in the second CMR set that is QCLed with the one of the first CMRs in the first CMR set.

47. The wireless device of claim 39, wherein:
at least one of the first CMRs and the second CMRs includes Synchronization Signal Block (SSB) or Channel State Information Reference Signal (CSI-RS) including periodic CSI-RS or semi-persistent CSI-RS, and
at least one of the first IMRs and the second IMRs comprises a non-zero power (NZP) IMR, which includes the SSB or the CSI-RS including the periodic CSI-RS or the semi-persistent CSI-RS.

48. The wireless device of claim 47, wherein the wireless device is further configured to:
receive additional information from the network device, wherein the additional information indicates configuring a first zero power (ZP) IMR for each of the first CMRs in the first CMR set and a second ZP IMR configured for each of the second CMRs in the second CMR set; and
perform the L1-SINR measurement further based on the additional information, wherein the first ZP IMR and the second ZP IMR includes Channel State Information Interference Measurement (CSI-IM).

49. The wireless device of claim 39, wherein the wireless device is further configured to:
for another CMR pair which does not belong to the multiple CMR pairs used to perform the L1-SINR measurement:
do not generate a first report of the L1-SINR measurement for the another CMR pair; or
generate a second report of the L1-SINR measurement for the another CMR pair, and the second report does not include information related to the inter-beam interference for the beams associated with the first TRP and the second TRP.
